(19) United States
(12) Patent Application Publication
(10) Pub. No.: US 2008/0069629 A1
(43) Pub. Date: Mar. 20, 2008

(54) Novel Binders and Folders

(76) Inventors: Steven Kenneth Beuselinck, Rancho Santa Margarita, CA (US); Michael James Turri, Rochester, NY (US); Robert Friedland, La Mirada, CA (US)

Correspondence Address: PATENTMETRIX, 14252 CULVER DR. BOX 914, IRVINE, CA, 92604, US

(21) Appl. No.: 11/469,373

(22) Filed: Aug. 31, 2006

(51) Int. Cl. B42F 13/00

(52) U.S. Cl. 402/73

(57) ABSTRACT

The present invention is directed toward folder embodiments with base plates and ring assemblies capable of being removably attached to the spine portion of the folder. The present invention is also directed toward folder embodiments with a magnetized surface and various recreational and educational representations on that magnetized surface.

### FIELD OF THE INVENTION

The present invention relates generally to novel stationery, and more specifically to a novel folder of flexible use that can be optimally stored and easily transported in disassembled form. Additionally, the present invention relates, more specifically, to novel folders or binders that can provide educational, organizational, or recreational value to users.

### BACKGROUND OF THE INVENTION

Ring binders or folders used for photo albums, parts catalogs, presentation kits, student notes, classroom materials, and office records typically include a plurality of generally O-, U- or D-shaped metal rings for holding apertured sheets of paper or the like. These rings, typically on the order of two or three, are fixed to a metal spine, which, in turn, is permanently attached to the spine of the binder/folder. The rings can range in size from ¼ in., ½ in., ¾ in., 1 in., 1.5 in., 2 in., 2.5 in., 3 in., 3.5 in., 4 in., 4.5 in., 5 in., 5.5 in., 6 in., 6.5 in., 7 in., 7.5 in., 8 in., 8.5 in., 9 in., 9.5 in., 10 in. or more in diameter. In each case, a user, operating an apparatus integrated into the metal spine, can cause the ring structure to separate, thereby allowing the user to remove, replace or add sheets.

Such conventional ring binders have a number of shortcomings. Assembly costs represent a large percentage of the total cost of production. Empty binders occupy a substantial amount of unusable space, making it uneconomical to transport them over distances and requiring unnecessarily large storage spaces for inventories maintained by retailers or companies using a large number of binders.

Further, conventional binders/folders with fixedly attached ring structures are not flexible or adaptable to the requirements of a user. For example, a user cannot modify a single binder/folder for different uses. In particular, a user is unable to use a single binder/folder with multiple ring sets, each containing different contents. Instead, to reuse a conventional binder/folder, the user is required to take out all of the contents existing between the rings and replace it with new contents. Further, the user is limited to using conventional binders/folders with the same size rings and cannot repurpose, for example, a conventional binder/folder with 1.5 inch rings for use with 4-inch rings.

With respect to the recreational value of binders/folders, some binders have covers that are colored, printed with designs, and/or permanently decorated. However, there is a need to make the binders/folder capable of more interactive recreational activities. In particular, conventional folders/binders do not allow users to play conventional games, such as chess, checkers, or backgammon, nor do they allow for other activities, such as whiteboarding ideas or dressing dolls. While users can carry magnetic sets for gaming activities, these game sets are typically standalone single-purpose items and have to be carried separately from any binder/folder.

### SUMMARY OF THE INVENTION

According to an embodiment of the present invention a ring folder cover unit comprises front, back and spine portions. A base plate member is capable of being removably attached to the spine portion by suitable attachment means. Split ring members are mounted on the base plate member.

In one embodiment, the attachment means comprise snaps at both ends of the base plate such that they snap on to the spine portion of a folder when engaged.

In another embodiment, the attachment means comprise a first Velcro strip fixedly attached to the bottom of the base plate and a matching second Velcro strip fixedly attached to the exposed spine portion of a folder. To attach the base plate to the spine portion, the first Velcro strip is aligned with the second Velcro strip and pressed together, thereby creating a bond. Preferably, the bond is secured with additional attachment mechanisms, such as latches, snaps, or clips, to provide added support to the bond.

In another embodiment, the attachment means comprise a magnet strip fixedly attached to the bottom of the base plate and a matching magnetized strip surface fixedly attached to the exposed spine portion of a folder. To attach the base plate to the spine portion, the magnet strip is aligned with the magnetized strip surface and pressed together, thereby creating a bond. Preferably, the magnetic bond is dislodged using a dislodging mechanisms, such as a lever or latches, that a user can activate in order to separate the base plate from the spine portion.

In another embodiment, the spine portion comprises a metal fixture having a track within which base plate member can be slidably inserted.

Another embodiment of the invention additionally and optionally comprises a divider panel between the front and the back portions of the ring folder cover unit.

It is another object of the present invention to provide a ring folder cover unit that can be disassembled and assembled with ease.

It is also an object of the present invention to provide a ring folder cover unit that can be disassembled and stored or packaged in a way that the folder occupies minimal storage space.

According to another embodiment at least one folder cover or divider surface is magnetized and comprises a layered structure. A metal sheet layer is mounted on a support sheet layer. The support sheet layer can be made of any suitable rigid material, including cardboard or plastic. Alternatively, the folder cover comprises a base support layer that can be made of any suitable rigid material, including cardboard or plastic, and a paint layer that comprises iron particles enabling a magnetized surface.

In accordance with an objective of the invention the exposed surface of the folder cover or divider is provided with printed representation of recreational and/or educational references such as chess, checkers, backgammon, periodic tables, word games, doll sets, or any other image. Collateral magnetic pieces are also provided in association with the folder/binder.

According to another embodiment separate magnetic sheets are provided that, in turn, have printed recreational or educational references thereon. The magnetic plastic sheets with printed games or educational references are placed on the folder such that users can use magnetic pieces to use the printed references on the magnetic plastic sheets.

In one embodiment, the folder comprises a front panel having a longitudinal edge portion, a back panel having a longitudinal edge portion, a spine for hinging together said longitudinal edge portions of the front panel and the back panel, a base plate member having a ring assembly, and an attachment mechanism that removably attaches said base plate member to said spine. Optionally, the attachment mechanism comprises snaps fixedly attached to the base plate member and snap receivers positioned on said spine that mate with said snaps. Optionally, the attachment mechanism comprises snaps fixedly attached to the spine and snap receivers positioned on said base plate member that mate with said snaps.

Optionally, the attachment mechanism comprises a fixture having track a track fixedly attached to the spine within which at least a portion of said base plate member can be inserted. Optionally, the attachment mechanism comprises a fixture having track a track fixedly attached to the base plate member within which at least a portion of said spine can be inserted.

Optionally, the attachment mechanism comprises a plurality of levers fixedly attached to the base plate member capable of latching onto the spine. Optionally, the attachment mechanism comprises a plurality of levers fixedly attached to the spine portion capable of latching onto the base plate member.

In another embodiment, the folder comprises a front panel having a longitudinal edge portion, a back panel having a longitudinal edge portion, and a spine for hinging together said longitudinal edge portions of the front panel and the back panel, wherein at least one of said front panel and back panel comprises a magnetized layer. Optionally, the folder comprises a printed representation of a game on a surface of said magnetized layer.

Optionally, the printed representation is at least one of a chess board, checkers board, or backgammon board. Optionally, the folder comprises a pocket within which game pieces having a magnetized surface are stored. Optionally, the game pieces are at least one of chess game pieces, checkers game pieces, or backgammon game pieces.

Optionally, the folder comprises a printed representation of a figure, such as a doll, face, body, or animated character. Optionally, the magnetized layer comprises a metal sheet. Optionally, the magnetized layer comprises a sheet having magnetizable particles.

In another embodiment, the folder comprises a front panel having a longitudinal edge portion, a back panel having a longitudinal edge portion, and a spine for hinging together said longitudinal edge portions of the front panel and the back panel, wherein at least one of said front panel and back panel a support sheet, a magnetized metal sheet, and a surface sheet.

### BRIEF DESCRIPTION OF THE DRAWINGS

These and other features and advantages of the present invention will be further appreciated, as they become better understood by reference to the following Detailed Description when considered in connection with the accompanying drawings:

FIG. 1a shows an embodiment of a folder cover unit and a base plate member with rings and associated attachment means;

FIG. 1b shows an embodiment of the folder cover unit additionally comprising a divider panel;

FIG. 2a shows a metal fixture comprising a track for slidably inserting a base plate member therein;

FIG. 2b shows another embodiment of a folder cover unit and a base plate member with rings and associated attachment means;

FIG. 2c shows yet another embodiment of a folder cover unit and a base plate member with rings and associated attachment means;

FIG. 3 shows pages for storing CD/DVDs;

FIG. 4 shows pages for storing games;

FIG. 5 shows the composite layers of a magnetizable folder unit;

FIG. 6 shows a first recreational image capable of being printed on a magnetizable folder and associated magnetic pieces;

FIG. 7 shows a second recreational image capable of being printed on a magnetizable folder and associated magnetic pieces;

FIG. 8 shows a third recreational image capable of being printed on a magnetizable folder and associated magnetic pieces; and

FIG. 9 depicts a plurality of folder inserts capable of storing printed representations of recreational and/or educational references.

### DETAILED DESCRIPTION OF THE DRAWINGS

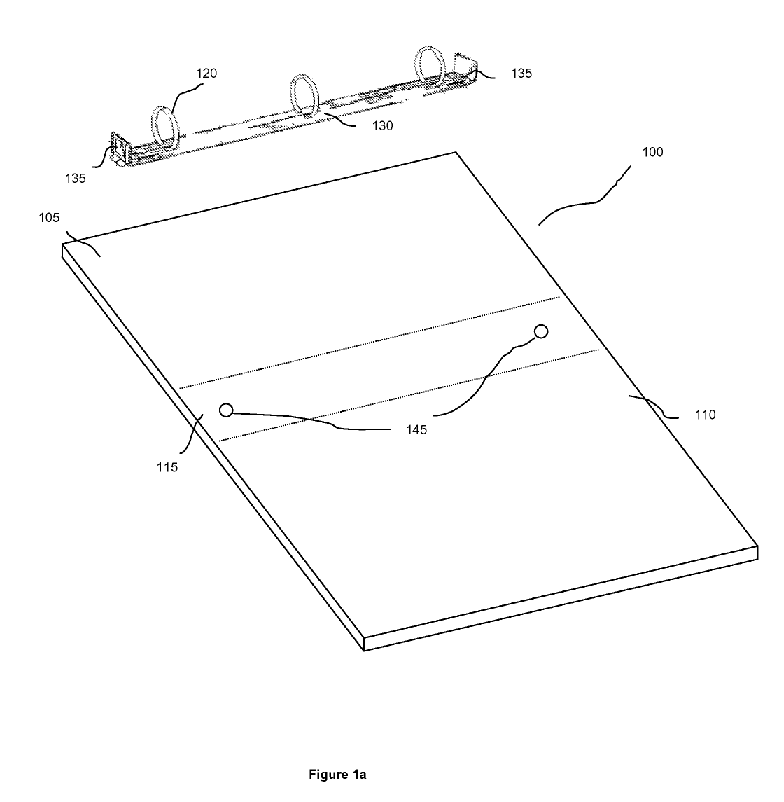

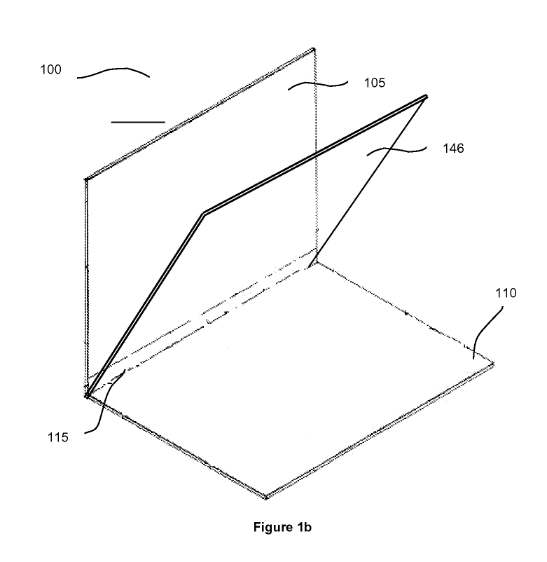

Referring to FIG. 1a, a document folder or ring binder assembly according to an embodiment of the present invention is shown to include a folder cover unit 100.

The folder cover unit 100 has a front panel portion 105, a back panel portion 110, and a spine portion 115 for hinging together adjacent longitudinal edge sections of the front and back panel portions 105, 110. The front and back panel portions 105, 110 are adapted to receive documents therebetween such that one edge of the documents extend toward the spine portion 115.

Conventional ring binders or folders comprise a base plate member that is permanently fastened or attached onto the spine portion, inside the folder unit by means of rivets, bolts or any other suitable fastening means known to persons of ordinary skill in the art. Fixedly mounted on the base plate member is a ring assembly that comprises a plurality of ring portions that are separable and terminate within a metal housing that encloses appropriate spring means for resiliently retaining the split rings in either a closed or open state. This structure is conventional and is therefore not illustrated. Tabs are provided to assist in opening or closing the rings and locking them in a closed position as is common with such loose-leaf ring binders.

Another embodiment of the folder unit 100 additionally comprises of a divider panel 146 as shown in FIG. 1b. The divider panel 146 is also hinged to spine portion 115, in a way that a user may easily punch holes in a document and place it in the ring binder without affecting the divider panel 146 in any way. The front and back panels 105, 110 that form the cover of the folder unit 100 of FIG. 1a and the divider panel 146 inside the folder unit 100 of the embodiment of FIG. 1b are composite structures.

Referring back to FIG. 1a, according to an embodiment of the present invention, the base member 130 comprises an attachment means capable of removably attaching the base member to the folder/binder spine portion 115, instead of being permanently fastened as in conventional ring binders.

In one embodiment, the attachment means comprises metal snaps 135. As shown in FIG. 1a the base member 130 comprises metal snaps 135 at the two end portions such that when the base member 130 is required to be mounted on the spine portion 115 a user could place the base member on the spine portion and engage the snaps 135 with snap receivers 145 such that they are tightly, but removably, bound to the spine portion 115.

Optionally, base member 130 can comprise multiple snaps, such as 3, 4, 5, 6, or more, which are tightly, but removably, engaged with an equal number of snap receivers, such as 3, 4, 5, 6, or more. Further, optionally, the base member 130 can include suitable spring and lever assemblies to secure the engagement of the snaps 135 into the snap receivers 145. One of ordinary skill in the art would appreciate that the snap receivers 145 are complementary to, and capable of tightly engaging with, the snaps 135.

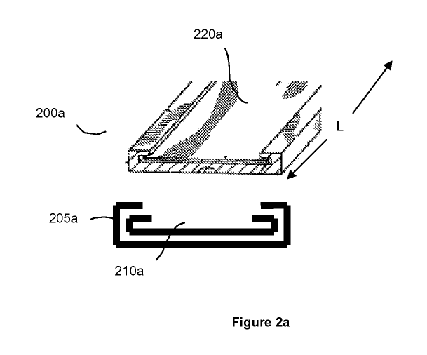

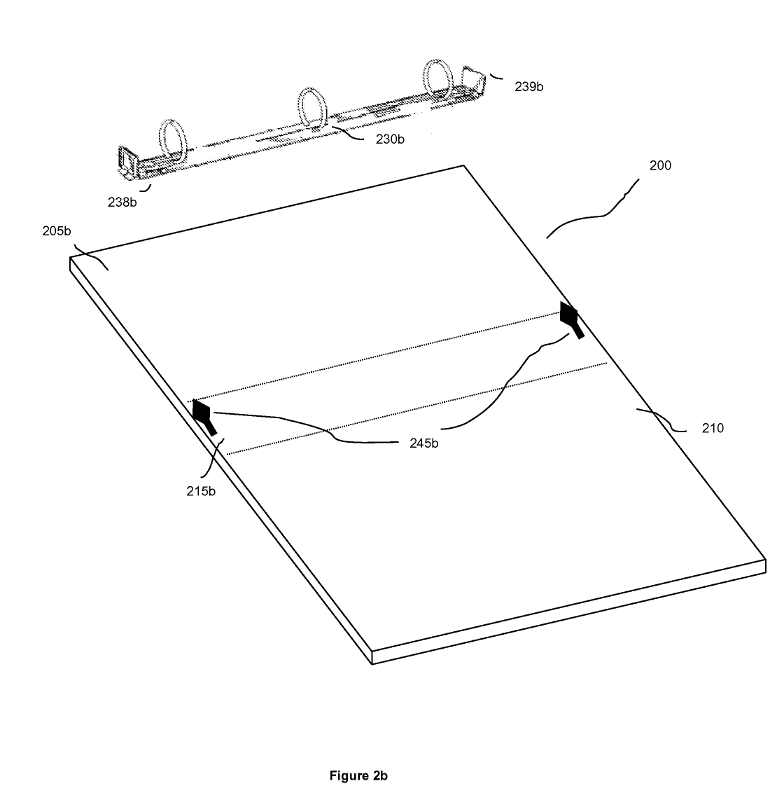

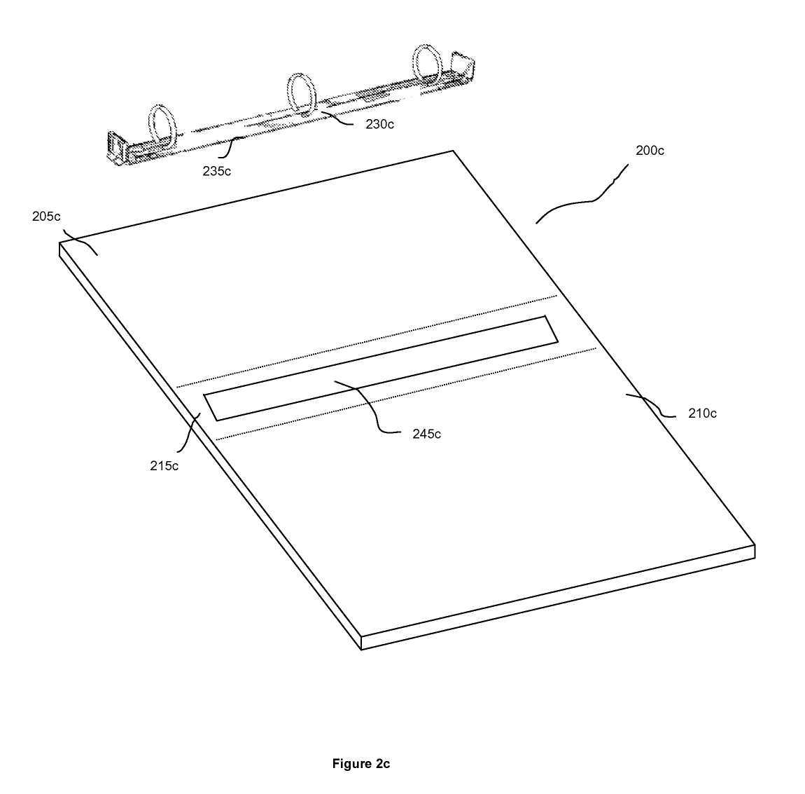

In another embodiment, the spine portion 115 comprises a metal fixture having a track within which base plate member can be slidably inserted. FIG. 2a shows a part of such a metal fixture 200a that can be attached to the spine portion of a binder using bolts, rivets or the snaps 135 of FIG. 1a. The metal fixture 200a is in the form of a metal housing 205a that has a track 210a running across the length ‘L’ of the fixture. A base plate member 220a is inserted from one end of the fixture and slid throughout the length of the fixture. The length of the fixture is such that it can slidably accommodate a base plate member of commercially available standard dimensions. Once the base plate slides in, it is press-fitted or locked in place using a level at one end. Attached to the base plate member 220a is a plurality of rings of any size.

Referring to FIG. 2b, the folder cover unit 200b has a front panel portion 205b, a back panel portion 210b, and a spine portion 215b for hinging together adjacent longitudinal edge sections of the front and back panel portions 205b, 210b. The front and back panel portions 205b, 210b are adapted to receive documents therebetween such that one edge of the documents extend toward the spine portion 215b. According to this embodiment of the present invention, the spine portion 215b comprises an attachment means capable of removably attaching the spine portion 215b to the folder/binder base member 230b, instead of being permanently fastened as in conventional ring binders.

In this embodiment, the attachment means comprises levers 245b that can latch onto the base member 230b at the end of the base member 239b or along the sides of the base member 238b. When the base member 230b is required to be mounted on the spine portion 215b, a user could place the base member on the spine portion and engage the levels 245b with base member end 239b or sides 238b such that they are tightly, but removably, bound to the spine portion 215b.

Referring to FIG. 2c, the folder cover unit 200c has a front panel portion 205c, a back panel portion 210c, and a spine portion 215c for hinging together adjacent longitudinal edge sections of the front and back panel portions 205c, 210c. The front and back panel portions 205c, 210c are adapted to receive documents therebetween such that one edge of the documents extend toward the spine portion 215c. According to this embodiment of the present invention, the spine portion 215c comprises an attachment means capable of removably attaching the spine portion 215c to the folder/binder base member 230c, instead of being permanently fastened as in conventional ring binders.

In this embodiment, the attachment means comprise a first Velcro strip 235c fixedly attached to the bottom of the base plate 230c and a matching second Velcro strip 245c fixedly attached to the exposed spine portion 215c of a folder. To attach the base plate 230c to the spine portion 215c, the first Velcro strip 235c is aligned with the second Velcro strip 245c and pressed together, thereby creating a bond. Preferably, the bond is secured with additional attachment mechanisms, such as latches, snaps, or clips, to provide added support to the bond.

Referring to FIG. 2c, the attachment means may alternatively comprise a magnet strip 235c fixedly attached to the bottom of the base plate 230c and a matching magnetized strip surface 245c fixedly attached to the exposed spine portion 215c of a folder. To attach the base plate 230c to the spine portion 215c, the magnet strip 235c is aligned with the magnetized strip surface 245c and pressed together, thereby creating a bond. Preferably, the magnetic bond is dislodged using a dislodging mechanisms, such as a lever or latches, that a user can activate in order to separate the base plate from the spine portion. It should be appreciated that the magnet strip can instead be placed on the spine portion of the folder and the magnetized strip can be placed on the bottom of the base plate.

While the illustrated embodiments above include three rings, as few as one ring and up to four or more can be used. In another embodiment the binder can be used without a folder cover unit 100. For instance, after records cease to be current, they can be transferred from a binder including a folder cover unit 100 to one including only one or more rings and a base plate member 130 for permanent storage. This partial assembly can be placed in a thin, inexpensive box-like cover to store the records on shelves.

Also it is an intention of the inventors that the ring binder of the present invention be used to store a variety of items other than papers. Thus, according to one embodiment, the invention provides a plurality of flexible, plastic, two-sided, pages 300 for storing a plurality of compact discs within a plurality of one-disc pockets that are contained on the two sides of the page 300, as shown in FIG. 3. In this manner, both physical and visual access is provided to discs. The CD storage page 300 in accordance with the invention contains a hole pattern that facilitates releasably mounting the CD storage page in three ring binders having ring diameters including ¼ in., ½ in., ¾ in., 1 in., 1.5 in., 2 in., 2.5 in., 3 in., 3.5 in., 4 in., 4.5 in., 5 in., 5.5 in., 6 in., 6.5 in., 7 in., 7.5 in., 8 in., 8.5 in., 9 in., 9.5 in., 10 in. or more in diameter. In one embodiment, the folder has a standard cover size generally associated with a general utility of holding text/graphics pages that have an 8.5 to 9.0 wide by 11 high inch size format. The size and hole pattern of the CD storage pages 300 will further vary depending upon the size and number of rings in a folder.

FIG. 4 shows another embodiment where pages 400 are attached to the rings of the binder 405. The pages 400 hold all the pieces of a particular game. The pages are removable from the binder rings permitting an individual to substitute different games within the system. As would be evident to persons of ordinary skill in the art, a plurality of such pages or sleeves can be used to store business cards, photographs, collector cards, post cards, stamps, or any other physical object. Referring to FIG. 9, a plurality of pages 910 are provided in a single folder 900. Each page can comprise a plurality of slots within which the business cards, photographs, collector cards, post cards, stamps, or any other physical object can be stored. The slots can be configured in any fashion and can comprise openings of any size or shape.

The ring binder of the present invention can be advantageously transported and even retailed in a knocked-down or unassembled condition and assembled at the point of use. For example, referring back to FIG. 1a, the rings and the base plate member 130 with the associated metal snaps 135 can be packaged in a Styrofoam packet. Several of these packets and a corresponding number of folder cover units 100 can be stacked into one carton for shipment. The folder cover units 100 can be stored in this unassembled condition and assembled with the base plate members and rings as needed for use. If desired, all the components for a binder can be packaged as a unit and sold to end users who do the assembling. In either case, the unassembled binders occupy substantially less space than many conventional binders of the same size. Assembly costs, a major part of the overall cost of conventional binders, are eliminated because the customer, retailer or someone else in the distribution chain does the actual assembly.

Because the ring binding mechanism can be transported in the unassembled condition and assembled at the point of use, it is possible to market and manufacture more cost effectively. Individual components can be manufactured in different countries and shipped to worldwide distribution centers.

It is also an intention of the inventors to enable users to derive enhanced utilities, such as recreational and/or educational, from the folder/binder. According to one embodiment of the invention, this is achieved by providing a magnetizable folder along with collateral magnetic products that together offer a plurality of recreational and/or educational use.

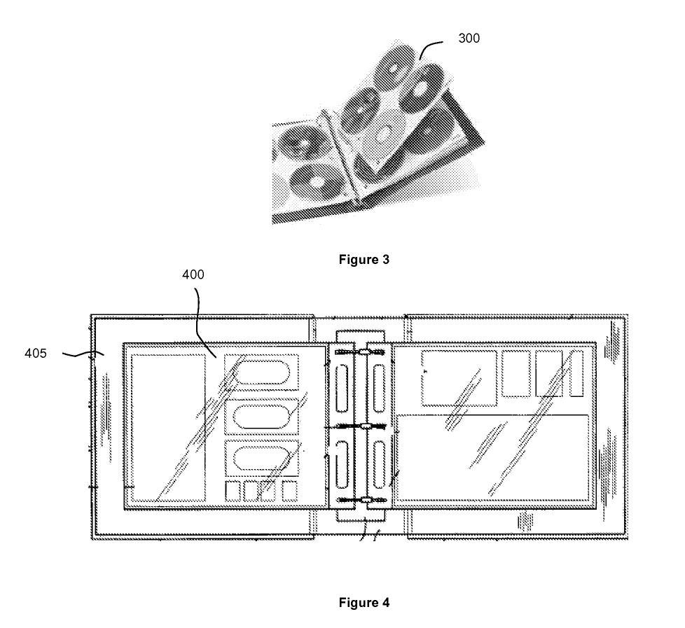

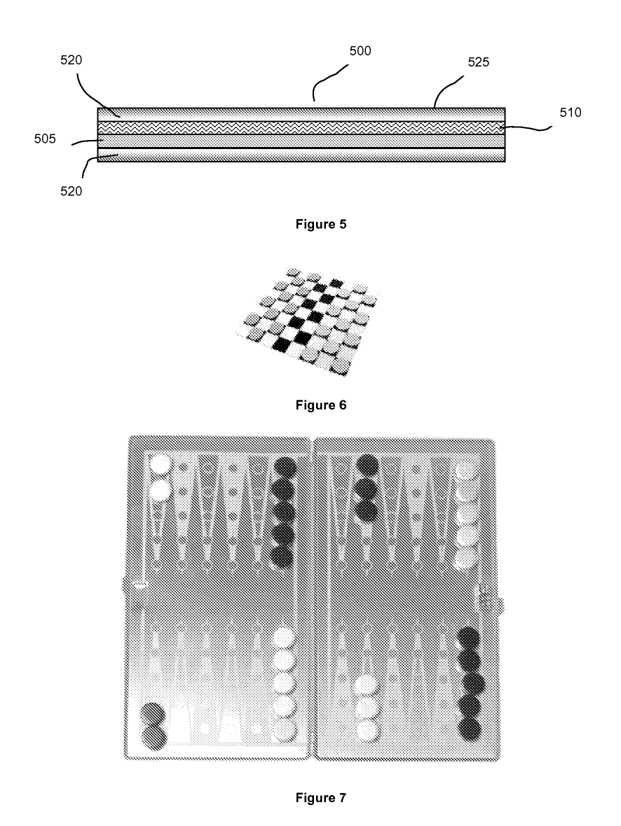

FIG. 5 shows a layered structure of a magnetizable folder 500 according to an embodiment of the invention. The folder 500 comprises a support sheet 505 of cardboard or any other suitable stiffening material known to persons of ordinary skill in the art. To the upper surface of the support sheet 505 is secured, by an adhesive, a thin sheet 510 of magnetizable metal, namely any metal or metal alloy that will cooperate with a permanent magnet of suitable strength to retain the magnet against movement thereon, even through an intervening thin sheet of non-magnetizable material. The support and metal sheets are sandwiched between a surface sheet 520 mounted over the metal sheet 510 which is of a self-adhesive, non-magnetizable material, such as paper or a PVC coated on one side with a pressure-sensitive adhesive. A layer of transparent laminate covers the surface sheet 520 and protects the underlying surface sheet from vagaries of use.

According to one embodiment the exposed surface 525 of sheet 520 is provided with a printed representation of a game such as chess, checkers, shoots and ladders, poem game with various words as pieces to be manipulated, backgammon, word scramble and/or of an educational utility such as periodic tables, general mathematics equations, logarithmic tables or any other recreational or educational reference evident to persons of ordinary skill in the art. It should be appreciated that the sheet can comprise two exposed surfaces, a bottom and a top, each with a different printed representation.

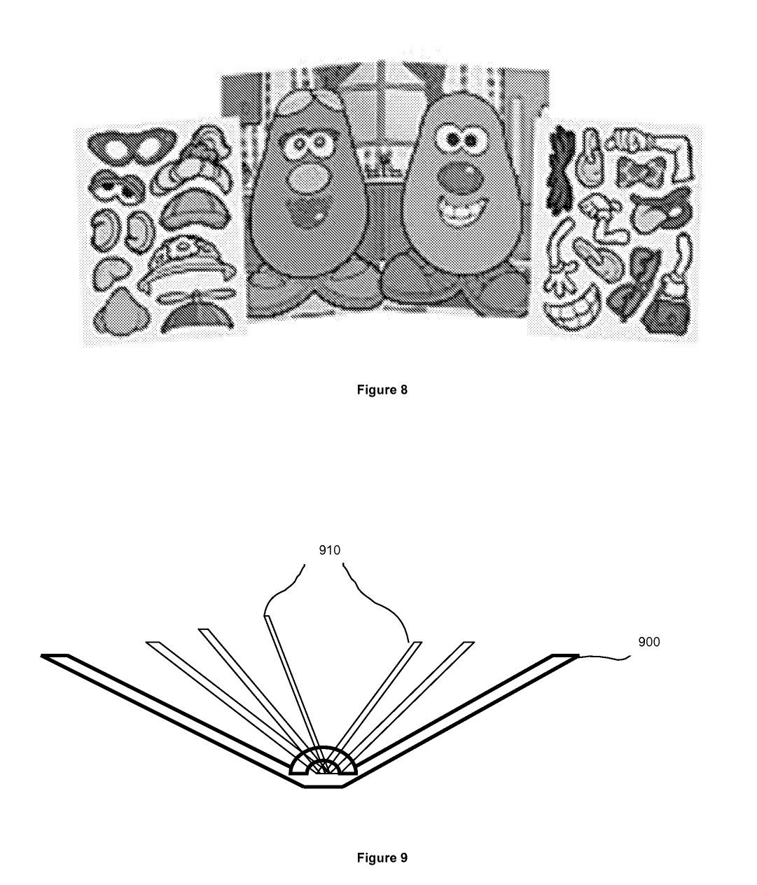

Collateral magnetic pieces are also provided that users can use with the game and/or educational reference printed on the surface 525. Thus, for example if the surface 525 has checkers printed thereon, as shown in FIG. 6, associated magnetic checker pieces are also provided that attach to the checker surface 525 owing to the magnetic effect between the pieces and the underlying magnetizable metal sheet 510. FIG. 7 shows backgammon game printed on surface 525 of the magnetizable folder with associated magnetic pieces. FIG. 8 shows another game of Mr. And Mrs. Potato Head. The Potato Head bodies are printed on surface 525 and the plurality of associated magnetic dresses and accessories are to the right and left of the Potato Head images.

According to one embodiment the collateral magnetic pieces are made of sheet permanent magnet material. As known to persons of ordinary skill in the art, sheet permanent magnet material is made by mixing powdered high-permeability ferrite material into a uniform mixture with a suitable settable plastic vehicle. The mixture is converted into strip or sheet form, and the plastic vehicle is set to provide a permanent stable product that usually is somewhat flexible, and that can readily be handled and made into elements of any desired shape by cutting and/or stamping. The ferrite material is permanently magnetized so that the resulting elements can act individually as permanent magnets, the magnetic field being of sufficient strength that they will adhere to a magnetizable metal surface, such as the surface of an iron or steel sheet, even through a sheet of paper or thin cardboard.

According to another embodiment of the invention, separate sheets of magnet material are provided that in turn have a layer of printed game or educational reference thereon. The magnetic sheets (with, for example, a checkers board or chess board design printed thereon) are placed on the folder, with the underlying magnetized metal sheet, such that the sheets firmly attach due to the magnetism and users can use associated magnetic pieces to use the recreational or educational reference printed on the magnetic sheets. The magnetic sheets can be made of any suitable material, including plastic or metal. It should also be appreciated that the folder's magnetized metal sheet can be on any surface of the front cover, the back cover, or a divider panel.

It should be evident to persons of ordinary skill in the art that while in the aforementioned embodiments the entire folder has the same layered structure this can vary in other embodiments. For example, in alternate embodiments the metal sheet layer is present in any or all of the front, back or spine portions. Similarly, in the divider panel embodiment of FIG. 1b the metal sheet layer is also present in any one or both of the exposed surfaces of the divider panel 145.

According to another embodiment, the metal sheet can be replaced with a layer of paint that includes magnetizable particles or metal flakes. Such metal paints are commercially available and known to persons of ordinary skill in the art.

It is an intention of the inventors to have multiple printed plastic game sheets, magnetic game pieces, collateral magnetized stationary products, and educational references that can be advantageously used in conjunction with the metal sheet or magnetizable paint layers.

What is claimed is:

1. A folder comprising
a front panel having a longitudinal edge portion;
a back panel having a longitudinal edge portion;
a spine for hinging together said longitudinal edge portions of the front panel and the back panel;
a base plate member having a ring assembly; and
an attachment mechanism that removably attaches said base plate member to said spine.

2. The folder of claim 1 wherein the attachment mechanism comprises snaps fixedly attached to the base plate member and snap receivers positioned on said spine that mate with said snaps.

3. The folder of claim 1 wherein the attachment mechanism comprises snaps fixedly attached to the spine and snap receivers positioned on said base plate member that mate with said snaps.

4. The folder of claim 1 wherein the attachment mechanism comprises at least two snaps fixedly attached to the base plate member and at least two snap receivers positioned on said spine that mate with said snaps.

5. The folder of claim 1 wherein the attachment mechanism comprises at least two snaps fixedly attached to the spine and at least two snap receivers positioned on said base plate member that mate with said snaps.

6. The folder of claim 1 wherein the attachment mechanism comprises a fixture having track a track fixedly attached to the spine within which at least a portion of said base plate member can be inserted.

7. The folder of claim 1 wherein the attachment mechanism comprises a fixture having track a track fixedly attached to the base plate member within which at least a portion of said spine can be inserted.

8. The folder of claim 1 wherein the attachment mechanism comprises a plurality of levers fixedly attached to the base plate member capable of latching onto the spine.

9. The folder of claim 1 wherein the attachment mechanism comprises a plurality of levers fixedly attached to the spine portion capable of latching onto the base plate member.

10. A folder comprising
a front panel having a longitudinal edge portion;
a back panel having a longitudinal edge portion; and
a spine for hinging together said longitudinal edge portions of the front panel and the back panel; wherein at least one of said front panel and back panel comprises a magnetized layer.

11. The folder of claim 10 comprising a printed representation of a game on a surface of said magnetized layer.

12. The folder of claim 11 wherein said printed representation is at least one of a chess board, checkers board, or backgammon board.

13. The folder of claim 10 further comprising a pocket within which game pieces having a magnetized surface are stored.

14. The folder of claim 13 wherein said game pieces are at least one of chess game pieces, checkers game pieces, or backgammon game pieces.

15. The folder of claim 10 comprising a printed representation of a figure.

16. The folder of claim 15 wherein said figure is at least one of a doll, face, body, or animated character.

17. The folder of claim 10 wherein the magnetized layer comprises a metal sheet.

18. The folder of claim 10 wherein the magnetized layer comprises a sheet having magnetizable particles.

19. A folder comprising
a front panel having a longitudinal edge portion;
a back panel having a longitudinal edge portion; and
a spine for hinging together said longitudinal edge portions of the front panel and the back panel; wherein at least one of said front panel and back panel a support sheet, a magnetized metal sheet, and a surface sheet.
